(19) United States
(12) Patent Application Publication
(10) Pub. No.: US 2010/0131837 A1
(43) Pub. Date: May 27, 2010

(54) VALIDATION FRAMEWORK

(75) Inventors: John Lindal, La Canada, CA (US); Brad Ciraulo, Menlo Park, CA (US)

Correspondence Address: BRINKS HOFER GILSON & LIONE / YAHOO! OVERTURE, P.O. BOX 10395, CHICAGO, IL, 60610, US

(73) Assignee: Yahoo! Inc., Sunnyvale, CA (US)

(21) Appl. No.: 12/323,148

(22) Filed: Nov. 25, 2008

(51) Int. Cl. G06F 17/00

(52) U.S. Cl. 715/234

(57) ABSTRACT

Methods and systems for validating input data are provided. Methods employed by the systems may include communicating validation configuration data to a first engine that validates input fields associated with a first communication interface, and generating, via a second engine, browser code operative to cause a browser to validate input fields of a web page associated with the browser code according to the validation configuration data, wherein input fields of the first communication interface and input fields of the web page that are related are validated according to a same set of validation configuration data. An error message may be displayed to a user of the first communication interface when an input field of the first communication interface is invalid. Error message display code may be embedded in the browser code. The error message display code may enable displaying an error message to a user viewing the web page associated with the browser code.

### BACKGROUND

The Internet has emerged as a powerful advertising tool. It is commonplace to see advertisements on many web sites. For example, advertisements may be displayed on search web sites and may be targeted to individuals based upon search terms provided by the individuals. Other web sites, such as news and sports web sites, may provide space for advertisements. The owners of these web sites may sell advertising space to advertisers to offset the costs associated with operating the web sites as well as to turn a profit.

In some cases, advertisers may wish to show their respective advertisements on a particular web site. Other advertisers may be less interested in specific web sites and more interested in displaying advertisements across several web sites that cater to a specified target audience. For example, an automobile advertiser may want an automobile advertisement displayed on web sites that relate to automobiles and racing.

To facilitate advertisement placement, system operators may provide exchange systems that allow web site publishers to post information that characterizes their respective web sites and also allow advertisers to search for web sites that target audiences to whom the advertisers wish to advertise. These systems typically enable an advertiser to book a number of advertisement impressions, where each impression corresponds to the display of an advertisement to an internet user.

In some cases, the system operators may provide a web page based interface through which publishers and advertisers may interact with the system. Some system operators may also provide an application-program-interface (API) to the exchange system that enables automating many of the functions provided via the web based interfaces. For example, the system operator may provide an API interface, such as a web-services interface defined by the World Wide Web Consortium (W3C).

Often times, the interfaces for the systems are created by different groups of developers. However, as the systems have become more and more complex it has become increasingly difficult to coordinate development activities. For example, in some cases, data for a particular input field may be specified via both a web based interface and an API. Different groups of developers working on the respective interfaces may have different assumptions about how to test the validity of the data. For example, the developers of the API may assume the data is valid if it contains less than 40 characters, while the developers of the web based interface may assume the data is valid if it contains less than 30 characters. Thus, the validity of the data in the input field depends on the interface through which the data enters into the system. These inconsistencies lead to inefficiencies in the system and confuse and frustrate both developers and users that interact with the system via the two interfaces.

### BRIEF DESCRIPTION OF THE DRAWINGS

FIG. 1 depicts an exchange system;

FIG. 2 schematically represents a validation structure of the exchange system;

FIG. 3 is an exemplary XML file that includes validation configuration data;

FIG. 4 is a flow diagram that describes the operation of a validation engine of the exchange system;

FIG. 5 is a flow diagram that describes the operation of a browser code generator of the exchange system;

FIG. 6a is an exemplary portion of a browser code template;

FIG. 6b is an exemplary representation of a validation object;

FIG. 6c is an exemplary validation script; and

FIG. 7 illustrates a general computer system, which may represent any of the computing devices referenced herein.

### DETAILED DESCRIPTION

The embodiments below relate to validation of user input in a web site advertising exchange system. Although the embodiments are described in terms of an exchange system, the embodiments are not so limited and may be utilized in any system that includes multiple interfaces through which users of the system interact. Generally, the exchange system provides an environment in which web site publishers specify information that characterizes their respective websites. For example, demographic information related to web sites' audience may be specified. Pricing information corresponding to advertisements displayed on the web sites may also be specified. Other information that characterizes the web site may also be provided.

The exchange system also enables advertisers to specify search criteria so as to enable matching advertisements to suitable web sites. For example, an advertiser may specify target audience information that describes the desired audience for the advertisement. The target audience information may include the gender and age of the desired audience that the advertiser wishes to target. Other information that specifies the target audience may also be provided.

In addition to publishers and advertisers, ad networks may also interact with the web site advertising exchange system. Ad networks generally represent a number of publishers, advertisers or both. Ad networks enable small publishers and/or advertisers, who would otherwise find the cost associated with internet advertising to be prohibitive, to participate in online advertising. For example, an advertiser who is unable to purchase a minimum number of advertisement impressions specified by a web site publisher may join an ad network of similarly situated advertisers who collectively can purchase the minimum number of advertisement impressions specified. As used here, the term impression corresponds to the display of an advertisement to a user. The more relevant the impression is to the user, the higher the quality of impression.

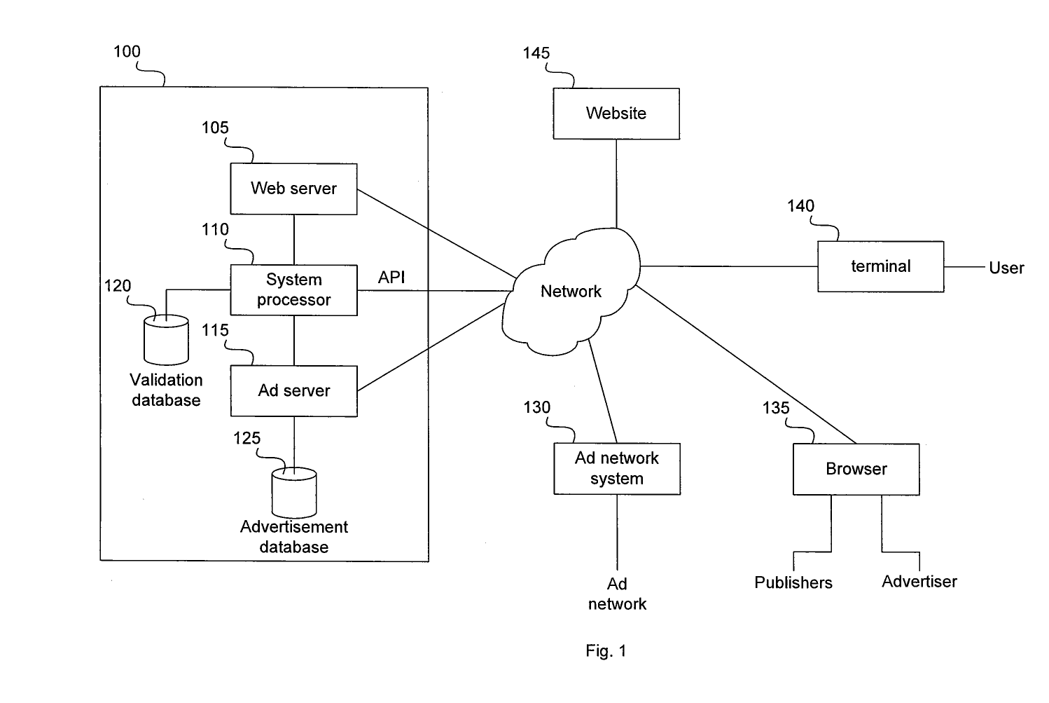

FIG. 1 depicts an exchange system 100. The exchange system 100 includes a web server 105, a system processor 110, an ad server 115, a validation database 120, and an advertisement database 125. The web server 105, system processor 110, and ad server 115 may correspond to any generalized computing device, such as an Intel®, AMD®, and/or PowerPC® based computer running an operating system, such as a Microsoft Windows®, Linux®, and/or Unix® operating system. The web server 105, system processor 110, and ad server 115 may be adapted to communicate with other computers via an interface, such as a network interface. The functionally associated with the web server 105, system processor 110, and ad server 115 may reside on a single computing device or be distributed among multiple computing devices.

The web server 105 may also be adapted to communicate web pages via the network interface to a browser 135. For example, the web server 105 may include a web server application, such as Apache HTTP Server or Microsoft's® Internet Information Server. The web pages communicated may include fields that enable publishers to interact with the exchange system 100. For example, fields may be provided that enable a website publisher to specify information related to a website, such as the URL of the web site, demographic information related to the website's audience, advertisement placement information, and/or advertisement size information.

Other web pages communicated may include fields that enable advertisers to interact with the exchange system 100. These fields may enable an advertiser to locate web sites suitable for hosting a given advertisement. For example, fields may be provided that enable specifying demographic information related to a desired audience, a date range for running an advertisement, advertisement position information and/or advertisement size information. In addition, fields may be provided that enable specifying key words to be associated with the advertisement and also for specifying a money amount the advertiser is willing to pay to have the advertisement shown. Other fields may enable uploading an advertisement, sometimes referred to as a creative, to be displayed.

Web pages generated by the web server 105 may include validation code operative to cause a browser 135 processing the web pages to check the validity of input fields. For example, the validation code may enable verifying that a URL includes an “@” symbol. The validation code may also enable verifying that a properly formatted date is entered into a date field or that the number of characters in a name field is less than a predetermined amount. The rules associated with the validation code may be stored in a validation database 120 and communicated to the web server 105 via the system processor 110. Embedding validation code in the web pages enables determining the validity of data in the input fields before the data is submitted to the web server 105. This in turn enables the user filling in the fields to correct any errors without delay.

Information communicated via the web pages above may be processed by the system processor 110. For example, the system processor 110 may be operative to store web site information provided by publishers to a database, and to generate a unique identifier (ID) and associate the ID with the web site. The ID may then be incorporated into web pages generated by the publisher's web site, and utilized to identify the web pages when targeting advertisements to the web pages.

The system processor 110 may also be operative to store information provided by an advertiser, such as demographic, date range, advertisement position, and/or advertisement size information, to a database. Creatives communicated by the advertiser may be stored to an advertisement database 125. The system processor 110 may then locate publisher web sites that match criteria specified by an advertiser and also association information that enables associating advertisements from the advertiser with the located web sites. The association information may be communicated to the ad server 115.

The system processor 110 may also provide an application-program-interface (API), such as a web services interface defined by the World Wide Web Consortium (W3C), that enables communicating the information described above to and from systems outside of the exchange system 100. For example, the API may enable communications with an ad network system 130 operated by an ad network agency. Ad network agency may prefer to utilize custom applications rather than the interface provided via the web server 105 to manage numerous publisher websites and/or advertisers. To facilitate these communications, the API may include functions that enable specifying publisher web site information, such as a URL of the web site, demographic information related to the website's audience, advertisement placement information, advertisement size information, or any other information a publisher may provide via the web page interface. Functions may also be provided that enable specifying advertiser information, such as demographic information related to a desired audience, a date range for running an advertisement, advertisement position information, advertisement size information, or any other information an advertiser may provide via the web page interface. Functions that enable specifying key words to be associated with the advertisement, and also for specifying a money amount the advertiser is willing to pay to have the advertisement shown may be provided. Other functions may be provided for uploading an advertisement, or creative, to be displayed on a web site. The functions identified above and the results returned from the functions may be communicated via a SOAP protocol defined by the World Wide Web Consortium (W3C).

The system processor 110 may include validation code operative to check the validity of data fields communicated via the API. For example, the validation code may enable verifying that an email address includes an “@” symbol. The validation code may also enable verifying that a properly formatted date is entered into a date field or that the number of characters in a name field is less than a predetermined amount. The rules associated with the validation code may be stored in a validation database 120. The validation rule applied to a given field specified via the API may also be applied to a corresponding field in a web page communicated by the web server 105. For example, the rules associated with checking the validity of a URL field specified via a web page may be the same as those rules applied to the corresponding URL field specified via the API. This approach provides a centralized mechanism for specifying validation rules for input fields.

The ad server 115 may be adapted to communicate advertisements stored in the advertisement database 125 to a browser operating on a user terminal 140 in response to a request for serving an advertisement. For example, web page information on a web site 145 may be communicated to a user terminal 140. The web page information may include a place holder for an advertisement. The place holder may correspond to an advertisement tag, or ad tag. The ad tag may include information that identifies the web page, such as a unique ID as described above. When processing the web page information, the browser operating on the user terminal 140 may communicate the ad tag to the ad server 115. In response, the ad server 115 may locate an advertisement previously associated with the unique ID and communicate the advertisement to the browser.

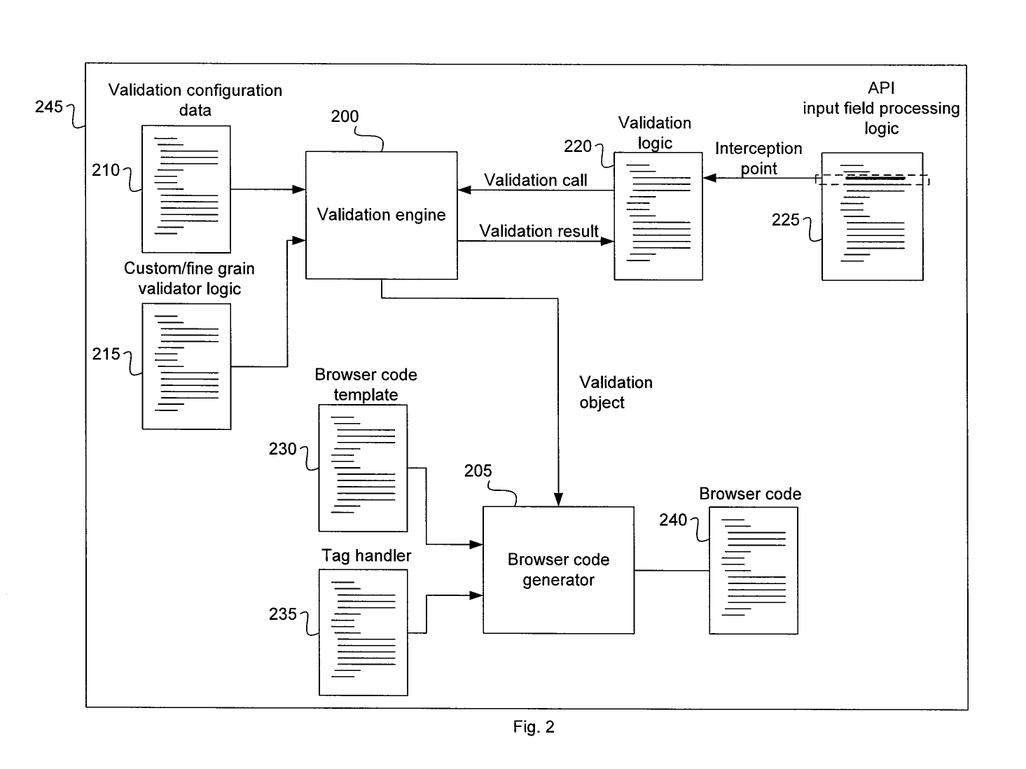

FIG. 2 schematically represents the validation structure 245 of the exchange system 100 of FIG. 1. The validation structure 245 includes a validation engine 200 and a browser code generator 205. The validation engine 200 corresponds to logic and/or code that enables determining whether data in input fields communicated to the system processor 110 conform to respective data formats. The validation engine 200 is configured via validation configuration data 210. The validation configuration data 210 defines the relationship between various data fields and validators utilized to validate data in the data fields. For example, the validation configuration data 210 may associate a URL data field with a validator that includes logic and/or code that enables verifying that the URL in the field is specified correctly. The validation configuration data 210 may also specify parameters that control the behavior of a given validator. For example, the validation configuration data 210 may define a maximum length parameter utilized by a string validator to verify the maximum length of a text string.

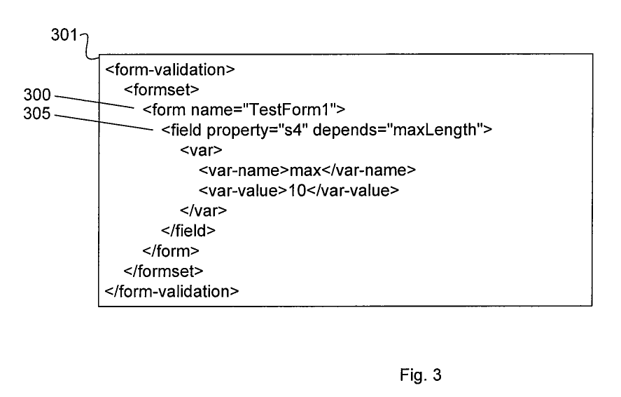

In one embodiment, the validation configuration data resides in an extensible-markup-language (XML) file. An exemplary XML file that includes validation configuration data 210 is shown in FIG. 3. Referring to FIG. 3, the exemplary XML file 301 includes a form directive 300 and a field directive 305. The form directive 300 includes a name parameter. The name parameter corresponds to the name of an object utilized by the exchange system 100 of FIG. 1 to encapsulate one or more input fields. The field directive 305 includes a property parameter that corresponds to the name of the input field within the object to be validated. In this example, an input field named “s4” within the “TestForm1” object is to be validated according to a “maxLength” rule. The “maxLength” rule corresponds to logic and/or code operative to cause a processor, such as the system processor 110 of FIG. 1, to determine whether the number of characters within an input field is less than a defined maximum amount. In this example, the defined maximum amount is equal to 10.

Referring back to FIG. 2, the logic and/or code that defines the validator may reside in the validation engine 200. For example, logic and/or code that defines commonly utilized validators, such as validators for URL fields, date fields, and name fields, may reside within the validation engine 200. Logic and/or code that defines custom and/or fine grain validators 215 may reside outside of the validation engine 200. For example, the logic and/or code that defines operations of a validator that relies on information in a database to validate a given input field may reside in an external location, such as a text file stored on a computer hard drive.

In one embodiment, the validation engine 200 corresponds to an instance of an Apache Commons Validator. Apache Commons Validator is a reusable Java Technology® component managed by the Apache community, which is an association of developers that create and maintain Java Technology® components.

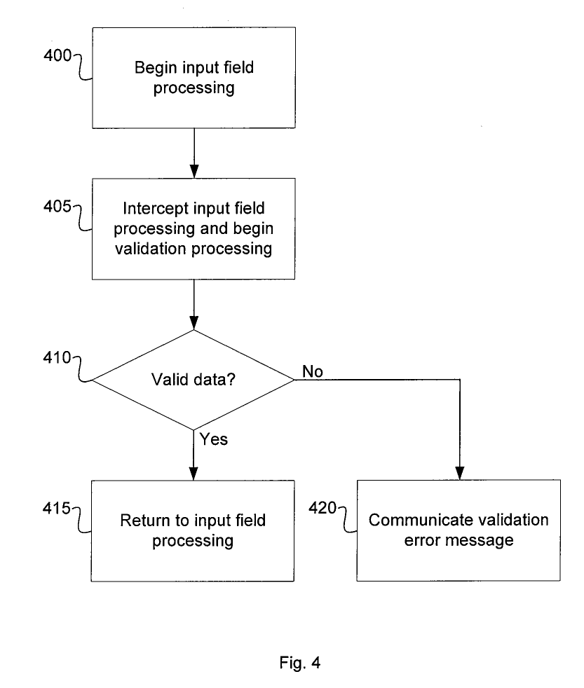

FIG. 4 is a flow diagram that describes operations of the validation engine 200 of FIG. 2. At block 400, operations defined by input field processing logic and/or code 225 (FIG. 2) may be executed. The input field processing logic and/or code 225 may define operations involved in processing a given input field. For example, the operations that define the processing of a URL input field may be defined. The operations may include procedures for retrieving the input field via the API of the system processor of FIG. 1 and for storing the input field to a database.

At block 405, operations defined by validation logic and/or code 220 (FIG. 2) may be executed. The operations defined may be triggered by a specific operation within the input field processing logic and/or code 225. For example, the input field processing logic and/or code 225 may include a function call operation that causes the operations defined by the validation logic and/or code 220 to be executed. In one embodiment, the validation logic and/or code 220 corresponds to an aspect-oriented-program (AOP). An AOP enables developers to add methods, fields, and/or interfaces to existing Java classes from within an AOP. The AOP includes pointcuts and interceptors. Pointcuts allow developers to specify join points that correspond to well-defined moments in the execution of a program, such as a method call, object instantiation, or variable access. The interceptor corresponds to logic and/or code that executes before, after, or around the specified join point.

The AOP pointcut and interceptor are utilized to effectively insert the validation logic and/or code 220 described above into the input field processing logic and/or code 225 as a pre-condition for processing input fields. For example, a pointcut may be utilized to specify a join-point before any operation that submits data from an input field to a database for storage. Then, prior to storing the data from the input field to the database, the flow of logic may switch to the interceptor, which in turn executes the validation logic and/or code 220. The interceptor may then validate data in the input field via the validation engine.

At block 410, if the data is valid, then at block 415, the flow of logic may switch back to the input field processing logic and/or code 225. Continuing with the example above, the data in the input field may be stored to the database. If at block 410, the data is not valid, then at block 420, a validation error message may be communicated to the source of the data in the input field. For example, if the data in the input field was communicated from the ad network system 130 of FIG. 1, a validation error message may be communicated to the ad network system 130. The validation error message may then be presented to a user of the ad network system 130.

Returning to FIG. 2, the browser code generator 205 corresponds to logic and/or code operable to cause a processor, such as the system processor 110 or web server 105 of FIG. 1, to generate validation enabled browser code. The browser code generator 205 accomplishes this by inserting validation logic into a browser code template 230 that includes input fields. The validation logic inserted is based on the same validation configuration data 210 utilized by the validation engine 200. The validation configuration data 210 may be communicated directly to the browser code generator 205 or be parsed and encapsulated into a validation object, such as a Java® bean, and then communicated to the browser code generator 205. In one embodiment, the browser code generator 205 corresponds to a Java Server Page (JSP) engine and the browser code template 230 corresponds to a hyper-text-markup-language (HTML) description of a web page that includes JSP tags defined below.

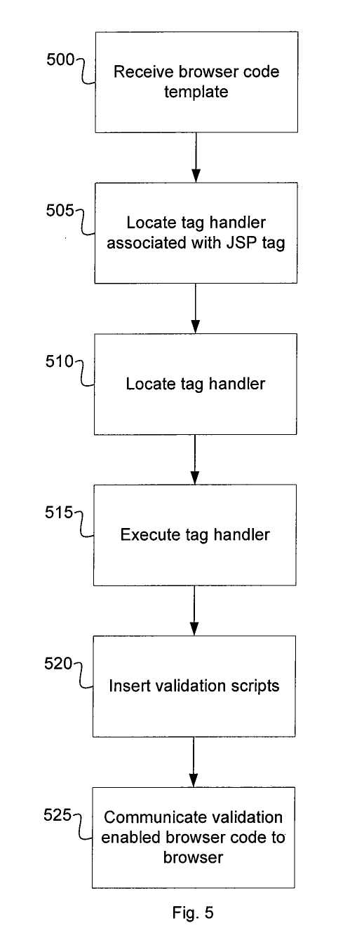

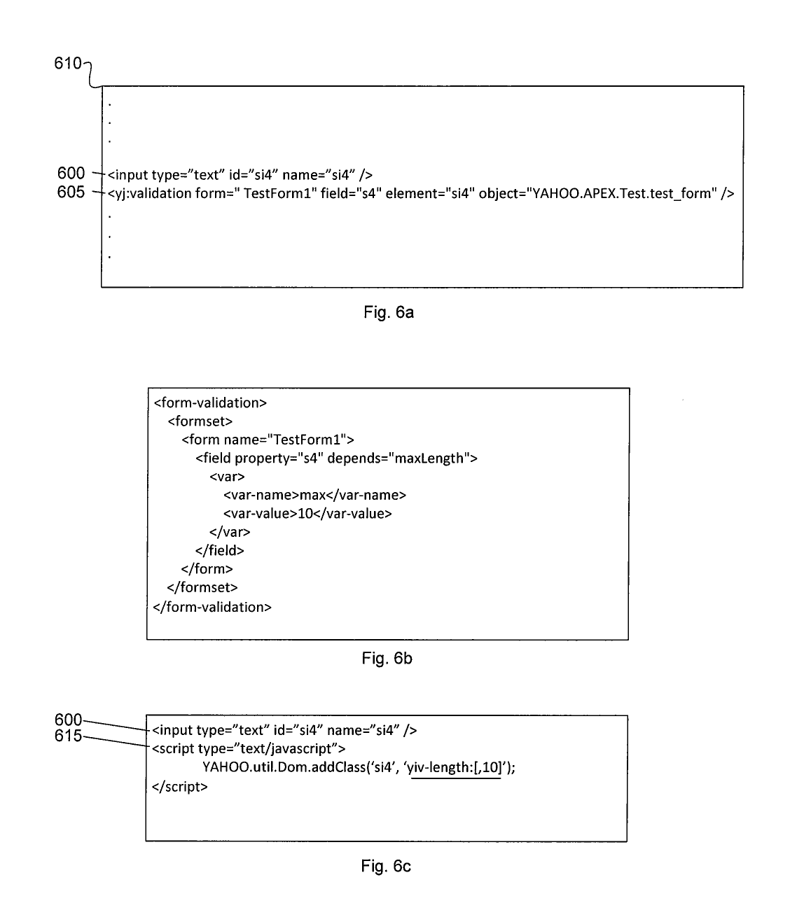

FIG. 5 is a flow diagram that describes the operation of the browser code generator 205 within the validation structure 245 (FIG. 2) of the exchange system 100 of FIG. 1. At block 500, a browser code template 230 (FIG. 2) may be received. For example, the browser code generator 205 may read a text file that includes the browser code template 230. FIG. 6a is a browser code template portion 610 that may be read. The browser code template portion 610 includes HTML text that defines an input field 600 of a web page to be generated from the browser code template portion 610. In this case, the input field 600 corresponds to a text field and is identified via the id “si4”.

The browser code template portion 610 also includes a JSP tag 605. JSP tags are directives embedded in browser code that are utilized by a JSP engine to modify the content of browser code. The JSP engine replaces the JSP tag according to instructions provided in a tag handler, such as the tag handler 235 of FIG. 2. The tag handler 235 includes logic and/or code operative to cause the JSP engine to replace a JSP tag with HTML browser code or scripting commands.

In this example, the JSP tag 605 includes parameters that specify a validation rule for the input field 600. For example, the JSP tag 605 specifies that the validation rules associated with the field “s4” of the form “TestForm1” are to be applied to the “si4” element, which corresponds to the input field 600 in the browser code template portion 610.

At block 505, the browser code generator 205 locates a validation tag handler 235 associated with the JSP tag 605. The tag handler 235 corresponds to logic and/or code operative to cause the browser code generator 205 to replace the JSP tag 605 with a validation script defined by the parameters in the JSP tag 605.

At block 510, the browser code generator 205 may locate the validation tag handler 235 associated with the JSP tag 605. For example, the browser code generator 205 may search through the validation object shown in FIG. 6b, which may be communicated from the validation engine 200 for a rule associated with the object and field specified in the JSP tag 605, which in this example is the “maxLength” rule described earlier.

At block 515, the logic and/or code in the tag handler 235 may cause the browser code generator 205 to replace the JSP tag 605 with a script 615 operable to cause a browser to determine the validity of an input field 600. For example, the browser code generator 205 may replace the JSP tag 605 with the script 615 shown in FIG. 6c. In one embodiment, the script 615 is operable to cause a browser to attach meta-data to an input field 600. The meta-data defines the validation rule to apply to the input field 600. For example, referring to FIG. 6c, the string “yiv-length:[,10]” may be added as metadata to the input field 600 with the ID “si4”. “yiv-length:[,10]” may correspond to a directive to a validation script indicating that the corresponding field have less than or equal to 10 characters.

At block 520, the tag handler 235 may cause the browser code generator 205 to insert validation scripts operable by a browser to test the validity of input fields prior to allowing data in the input fields to be submitted to a web server. The validation script may analyze the meta-data attached to an input field to determine the type of validation test to perform. Then the validation script may pass data in the input field to an appropriate validation procedure. The validation procedure may then determine the validity of the data in the input field. For example, in the case of the input field 600 above, the validation script may pass the data in the input field 600 to a validation procedure that determines whether the length of the data is less than or equal to 10 characters.

At block 525, the validation enabled browser code generated at block 520, is communicated to a browser, such as a browser 135 of FIG. 1. The browser 135, in turn, displays a web page defined by the validation enabled browser code. The web page may include a plurality of input fields that may be filled with data. In one embodiment, the validation scripts embedded at block 520 are executed by the browser 135 before data in the fields is submitted to a web server, such as the web server 105 of FIG. 1. If the data in a field is invalid, then a message may be communicated to the user of the browser 135. For example, an error message identifying the field with the invalid data may be displayed to the user, allowing the user to correct the error. If the data is valid, then the data may be submitted to the web server 105. Determining the validity of the data in the browser as opposed to communicating the data to the web server 105 and waiting for the web server 105 to determine the validity and communicate any errors back, provides quick feedback to the user, which in turn saves the user time.

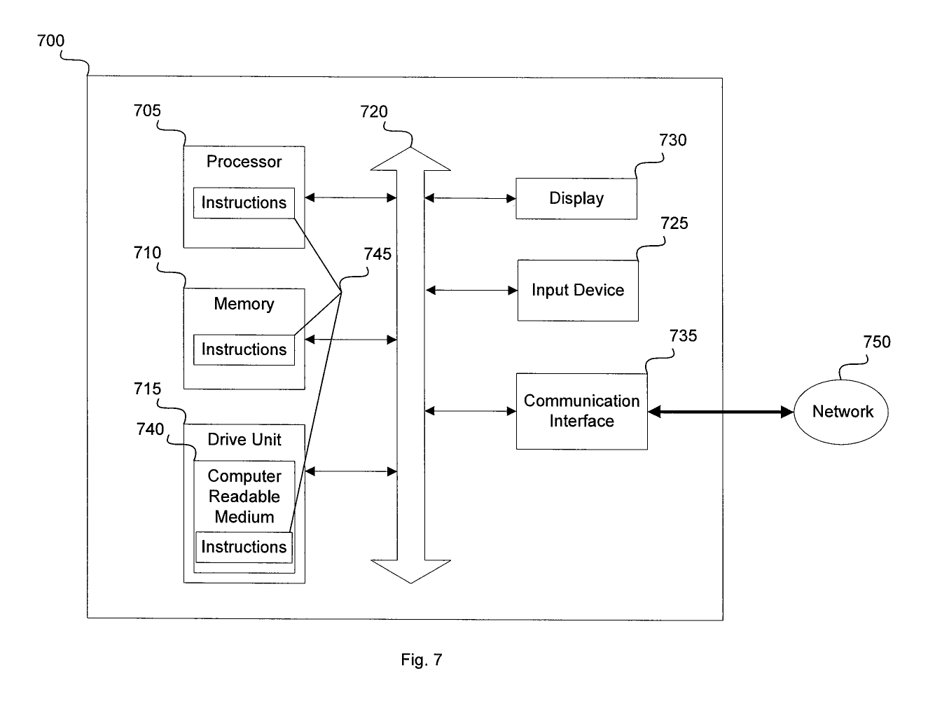

FIG. 7 illustrates a general computer system 700, which may represent web server 105, system processor 110, and ad server 115 of FIG. 1, or any of the other computing devices referenced herein. The computer system 700 may include a set of instructions 745 that may be executed to cause the computer system 700 to perform any one or more of the methods or computer-based functions disclosed herein. The computer system 700 may operate as a stand-alone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 700 may also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions 745 (sequential or otherwise) that specify actions to be taken by that machine. In one embodiment, the computer system 700 may be implemented using electronic devices that provide voice, video or data communication. Further, while a single computer system 700 may be illustrated, the term “system” shall also be taken to include any collection of systems or sub-systems that individually or jointly execute a set, or multiple sets, of instructions to perform one or more computer functions.

As illustrated in FIG. 7, the computer system 700 may include a processor 705, such as a central processing unit (CPU), a graphics processing unit (GPU), or both. The processor 705 may be a component in a variety of systems. For example, the processor 705 may be part of a standard personal computer or a workstation. The processor 705 may be one or more general processors, digital signal processors, application specific integrated circuits, field programmable gate arrays, servers, networks, digital circuits, analog circuits, combinations thereof, or other now known or later-developed devices for analyzing and processing data. The processor 705 may implement a software program, such as code generated manually (i.e., programmed).

The computer system 700 may include a memory 710 that can communicate via a bus 720. For example, validation database and/or advertisement database may be stored in the memory. In addition, logic and/or code that defines the validation configuration data 210, custom/fine grain validators 215, validation logic 220, API input field processing 225, browser code template 230, tag handler 235, browser code 240, validation engine 200, and/or the browser code generator 205 of FIG. 2. The memory 710 may be a main memory, a static memory, or a dynamic memory. The memory 710 may include, but may not be limited to, computer readable storage media such as various types of volatile and non-volatile storage media including, but not limited to, random access memory, read-only memory, programmable read-only memory, electrically programmable read-only memory, electrically erasable read-only memory, flash memory, magnetic tape or disk, optical media and the like. In one case, the memory 710 may include a cache or random access memory for the processor 705. Alternatively or in addition, the memory 710 may be separate from the processor 705, such as a cache memory of a processor, the system memory, or other memory. The memory 710 may be an external storage device or database for storing data. Examples may include a hard drive, compact disc (“CD”), digital video disc (“DVD”), memory card, memory stick, floppy disc, universal serial bus (“USB”) memory device, or any other device operative to store data. The memory 710 may be operable to store instructions 745 executable by the processor 705. The functions, acts or tasks illustrated in the figures or described herein may be performed by the programmed processor 705 executing the instructions 745 stored in the memory 710. The functions, acts or tasks may be independent of the particular type of instruction set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

The computer system 700 may further include a display 730, such as a liquid crystal display (LCD), an organic light emitting diode (OLED), a flat panel display, a solid state display, a cathode ray tube (CRT), a projector, a printer or other now known or later-developed display device for outputting determined information. The display 730 may act as an interface for the user to see the functioning of the processor 705, or specifically as an interface with the software stored in the memory 710 or in the drive unit 715.

Additionally, the computer system 700 may include an input device 725 configured to allow a user to interact with any of the components of system 700. The input device 725 may be a number pad, a keyboard, or a cursor control device, such as a mouse, or a joystick, touch screen display, remote control or any other device operative to interact with the system 700.

The computer system 700 may also include a disk or optical drive unit 715. The disk drive unit 715 may include a computer-readable medium 740 in which one or more sets of instructions 745, e.g. software, can be embedded. Further, the instructions 745 may perform one or more of the methods or logic as described herein. The instructions 745 may reside completely, or at least partially, within the memory 710 and/or within the processor 705 during execution by the computer system 700. The memory 710 and the processor 705 also may include computer-readable media as discussed above.

The present disclosure contemplates a computer-readable medium 740 that includes instructions 745 or receives and executes instructions 745 responsive to a propagated signal, so that a device connected to a network 750 may communicate voice, video, audio, images or any other data over the network 750. The instructions 745 may be implemented with hardware, software and/or firmware, or any combination thereof. Further, the instructions 745 may be transmitted or received over the network 750 via a communication interface 735. The communication interface 735 may be a part of the processor 705 or may be a separate component. The communication interface 735 may be created in software or may be a physical connection in hardware. The communication interface 735 may be configured to connect with a network 750, external media, the display 730, or any other components in system 700, or combinations thereof. The connection with the network 750 may be a physical connection, such as a wired Ethernet connection or may be established wirelessly as discussed below. Likewise, the additional connections with other components of the system 700 may be physical connections or may be established wirelessly.

The network 750 may include wired networks, wireless networks, or combinations thereof. The wireless network may be a cellular telephone network, an 802.11, 802.16, 802.20, or WiMax network. Further, the network 750 may be a public network, such as the Internet, a private network, such as an intranet, or combinations thereof, and may utilize a variety of networking protocols now available or later developed including, but not limited to, TCP/IP based networking protocols.

The computer-readable medium 740 may be a single medium, or the computer-readable medium 740 may be a single medium or multiple media, such as a centralized or distributed database, and/or associated caches and servers that store one or more sets of instructions. The term “computer-readable medium” may also include any medium that may be capable of storing, encoding or carrying a set of instructions for execution by a processor or that may cause a computer system to perform any one or more of the methods or operations disclosed herein.

The computer-readable medium 740 may include a solid-state memory such as a memory card or other package that houses one or more non-volatile read-only memories. The computer-readable medium 740 also may be a random access memory or other volatile re-writable memory. Additionally, the computer-readable medium 740 may include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that may be a tangible storage medium. Accordingly, the disclosure may be considered to include any one or more of a computer-readable medium or a distribution medium and other equivalents and successor media, in which data or instructions may be stored.

Alternatively or in addition, dedicated hardware implementations, such as application specific integrated circuits, programmable logic arrays and other hardware devices, may be constructed to implement one or more of the methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system may encompass software, firmware, and hardware implementations.

Accordingly, the method and system may be realized in hardware, software, or a combination of hardware and software. The method and system may be realized in a centralized fashion in at least one computer system or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The method and system may also be embedded in a computer program product, which includes all the features enabling the implementation of the methods described herein and which, when loaded in a computer system, is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

As can be seen from above, the embodiments described provide a methodology for validating user input received via one or more interfaces. For example, validation configuration information may be utilized by a validation engine to validate input data received via an API, such as an API provided on an exchange system. The same validation configuration may also be communicated to a browser code generator and utilized to embed validation logic and/or code into browser code generated by the browser code engine. The embedded validation logic may be operative to cause a browser to validate data received via a corresponding web page before data on the web page is submitted to a web server. One advantage of this approach is that it consolidates the rules associated with validating user input in one location. Another advantage is that user input communicated via a web page is validated before being submitted. This enables providing quick feedback to a user entering the data.

While the method and system has been described with reference to certain embodiments, it will be understood by those skilled in the art that various changes may be made and equivalents may be substituted without departing from the scope. In addition, many modifications may be made to adapt a particular situation or material to the teachings without departing from its scope. Therefore, it is intended that the present method and system not be limited to the particular embodiment disclosed, but that the method and system include all embodiments failing within the scope of the appended claims.

We claim:

1. A method for validating input data, the method comprising:
communicating validation configuration data to a first engine that validates input fields associated with a first communication interface;
generating, via a second engine, browser code operative to cause a browser to validate input fields of a web page associated with the browser code according to the validation configuration data, wherein input fields of the first communication interface and input fields of the web page that are related are validated according to a same set of validation configuration data.

2. The method according to claim 1, further comprising generating an error message to be displayed to a user of the first communication interface when an input field of the first communication interface is invalid.

3. The method according to claim 1, further comprising embedding error message display code in the browser code operative to display an error message to a user viewing the web page associated with the browser code when an input field of the web page is invalid.

4. The method according to claim 1, further comprising validating input fields associated with the first communication interface according to a set of fine grain validation procedures.

5. The method according to claim 1, wherein the validation configuration data is specified in an XML format.

6. The method according to claim 1, wherein the second engine corresponds to a Java Server Page® engine operable to replace Java Server Page® tags embedded in Java Server Page® code with validation code.

7. The method according to claim 1, wherein the first engine is based on an Apache Commons Validator validation engine.

8. The method according to claim 1, further comprising parsing the validation configuration data and communicating a parsed representation of the validation configuration data to the second engine.

9. A machine-readable storage medium having stored thereon, a computer program comprising at least one code section for validating input data, the at least one code section being executable by a machine for causing the machine to perform acts of:
communicating validation configuration data to a first engine that validates input fields associated with a first communication interface;
generating, via a second engine, browser code operative to cause a browser to validate input fields of a web page associated with the browser code according to the validation configuration data, wherein input fields of the first communication interface and input fields of the web page that are related are validated according to a same set of validation configuration data.

10. The machine-readable storage according to claim 9, wherein the at least one code section comprises code that enables generating an error message to be displayed to a user of the first communication interface when an input field of the first communication interface is invalid.

11. The machine-readable storage according to claim 9, wherein the at least one code section comprises code that enables embedding error message display code in the browser code operative to display an error message to a user viewing the web page associated with the browser code when an input field of the web page is invalid.

12. The machine-readable storage according to claim 9, wherein the at least one code section comprises code that enables validating input fields associated with the first communication interface according to a set of fine grain validation procedures.

13. The machine-readable storage according to claim 9, wherein the validation configuration data is specified in an XML format.

14. The machine-readable storage according to claim 9, wherein the second engine corresponds to a Java Server Page® engine operable to replace Java Server Page® tags embedded in Java Server Page® code with validation code.

15. The machine-readable storage according to claim 9, wherein the first engine is based on an Apache Commons Validator validation engine.

16. The method according to claim 1, wherein the at least one code section comprises code that enables parsing the validation configuration data and communicating a parsed representation of the validation configuration data to the second engine.

17. A system for validating input data, the system comprising:
a validation engine operative to validate input fields associated with a first communication interface according to validation configuration data communicated to the validation engine; and
a browser code generator operative to generate browser code that is operative to cause a browser to validate input fields of a web page associated with the browser code according to the validation configuration data, wherein input fields of the first communication interface and input fields of the web page that are related are validated according to a same set of validation configuration data.

18. The system according to claim 17, wherein the validation engine is operable to generate an error message to be displayed to a user of the first communication interface when an input field of the first communication interface is invalid.

19. The system according to claim 17, wherein the browser code generator is operable to embed error message display code in the browser code operative to display an error message to a user viewing the web page associated with the browser code when an input field of the web page is invalid.

20. The system according to claim 17, wherein the validation engine is operable to validate input fields associated with the first communication interface according to a set of fine grain validation procedures.

21. The system according to claim 17, wherein the validation configuration data is specified in an XML format.

22. The system according to claim 17, wherein the second engine corresponds to a Java Server Page® engine operable to replace Java Server Page® tags embedded in Java Server Page® code with validation code.

23. The system according to claim 17, wherein the first engine is based on an Apache Commons Validator validation engine.

24. The system according to claim 17, wherein the validation engine is operative to parse the validation configuration data and communicate a parsed representation of the validation configuration data to the browser code engine.
